(19) United States
(12) Patent Application Publication
(10) Pub. No.: US 2004/0037567 A1
(43) Pub. Date: Feb. 26, 2004

(54) Transceiving device

(76) Inventors: Fredrik Tjerneld, Uppsala (SE); Par Rosander, Uppsala (SE)

Correspondence Address: YOUNG & THOMPSON, 745 SOUTH 23RD STREET 2ND FLOOR, ARLINGTON, VA, 22202

(21) Appl. No.: 10/333,363

(22) PCT Filed: Jul. 13, 2001
(86) PCT No.: PCT/SE01/01618

(30) Foreign Application Priority Data
Jul. 20, 2000 (SE) 0002725-0

(51) Int. Cl. H04B 10/04

(52) U.S. Cl. 398/127; 398/201

(57) ABSTRACT

The present invention relates to an optical transmitter unit (10) comprising a transmitter unit comprising at least one source (9) of infra-red light mounted to a base member (6), for transmitting messages by means of infra-red signals. The transmitter unit further comprises a reflector (3) unit mounted on the base member (6), wherein said reflector has a number (n) of reflecting surfaces (31, 32, 33, 34, 35, 36) for transmission. It is designed to distribute the infra-red light from said at least one source in a predefined space having an arbitrary number of boundary surfaces in such a way that a substantially uniform signal power distribution is obtained on at one or more selected boundary surfaces of said predefined space.

### TECHNICAL FIELD

The present invention relates to a method for sending and receiving IR signals, an improved device for the same, and an electronic shelf label system comprising the inventive device.

### PRIOR ART AND BACKGROUND OF THE INVENTION

Certain problems associated with diffuse IR communications have since long been recognised. It is usually an object in constructing transmitters or transceivers to optimise signal strength. This may be difficult in certain physical environments as, for instance, is the case for one application for such IR communication systems, namely electronic shelf label (ESL) systems. Such systems are installed in consumer goods retail facilities, that represent many different environments like open areas with high ceiling, areas with shelves up to the ceiling in low ceiling areas and “cash and carry” type of environments with very high ceilings and very high shelves. One prior art way of solving this problem is to direct the light in specific desired directions in order to be able to lower the transmission power for the different environments to be covered.

IR transceivers are generally comprised of a printed circuit board (PCB), onto which infra-red light emitting diodes (IR-LEDs) are mounted, along with other necessary electronic components. If the IR-LEDs are simply mounted standing up on the PCB, then the signal distribution will be far from optimal, since in the case of a transceiver mounted in the ceiling, which is common for the ESL applications, the IR-LEDs will be pointing towards the floor. To compensate for this, an increase in signal strength is necessary. As is mentioned above, it is known to direct the lobes of the IR-LEDs in order to obtain a better signal distribution and this is achieved by bending the legs of the components mounted on the PCR, i.e. the IR-LEDs such that they are directed in the required orientation. This is a very time-consuming and expensive process, since this is has to be done in a separate step of the manufacturing process. The risk of breaking components, with a faulty transmitter or transceiver unit as a result, is of course obvious.

Another way to obtain a more directed IR-radiation is to use two or more PCBs for one transmitter or transceiver unit. According to this method, the individual PCBs, with the IR-LEDs mounted stranding on the PCB, are directed so as give the desired angular distribution. Namely, one PCB is horizontally arranged so as to direct the light downwards, and one or more PCB's are arranged at say 45° relative to the horizontal, and in a square configuration.

Although this method is preferable in comparison with the above method with bent components, it still suffers from certain disadvantages, Firstly, this method is also quite costly, since two or more PCBs have to be employed for one single transmitter or transceiver unit. Secondly, even if this method yields better results than a plane mounted PCB with standing components, it does not give the desired optimisation of the distribution of the transmitted signal power.

Thus, there exists a need for a transmitter or transceiver unit that is capable of providing an improved signal power distribution compared to the prior art devices.

### SUMMARY OF THE INVENTION

Thus, it is an object of the present invention to provide an improved IR transceiver which is easy and inexpensive to manufacture, and which provides improved reliability in the communications between a transceiver and a receiver, primarily for down-links, but also for up-links. This object is achieved with the invention as defined in claim 1.

By providing a reflector unit designed to reflect the light from a set of LED's in the desired direction, it will become an easy matter to change the system for various geometries. It will be sufficient to replace one component, namely the reflector. This is a great advantage compared to having to change the bending angle of the component legs, or to adjust the angle of inclination of the several PCB's.

It is also an object of the present invention to implement an IR transceiver in an electronic shelf label system in, for example, a consumer goods retail facility. This aspect is defined in claim 11.

### BRIEF DESCRIPTION OF THE DRAWINGS

The invention will now be described in closer detail, by way of non-limiting examples, reference being made to the appended drawings, in which:

FIG. 1 shows schematic views of different areas of distribution for IR light in e.g. a consumer goods retail facility, and different communication boundary surfaces,

FIG. 2 is an exploded view of one embodiment of a transceiver device according to the present invention,

FIG. 3 is a perspective view of a reflector unit,

FIGS. 4a-d are schematic illustrations of variants of the transceiver device according to the present invention, and

FIG. 5 is a functional diagram showing an ESL system incorporating the transmitter or transceiver device according to the present invention.

### DETAILED DESCRIPTION OF PREFERRED EMBODIMENTS

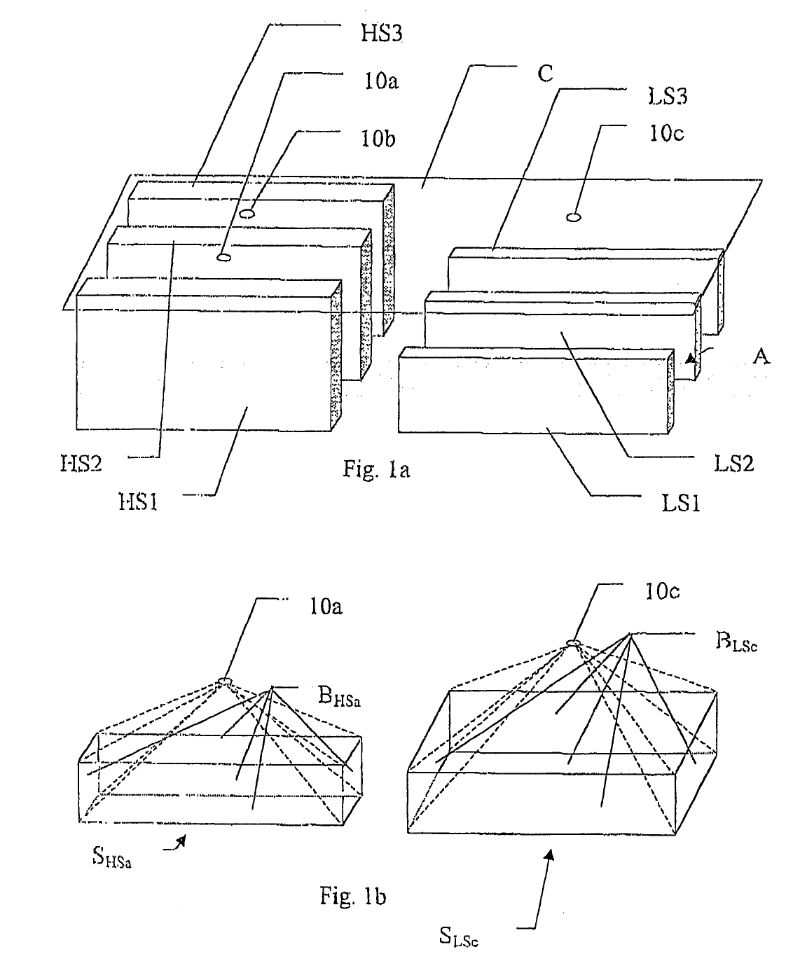

FIGS. 1a and 1b show schematically in perspective, simplified views of part of a store with high racking shelves HS1-HS3 and low shelves LS1-LS3. Typically high racking shelves are 4-8 m high and extend almost up to the ceiling C of the store. Typically, low shelves LS1-LS3 are about 2 metres high and there is empty space between the top of them and the ceiling C.

As the tops of the high racking shelves HS1-HS3 are so close to the ceiling C, a transceiver 10a, 10b for IR communication can normally only communicate with ESLs in the aisle A directly below it. Thus, each aisle A needs one transceiver 10a, 10b, mounted near to, or on to, the ceiling above it in order for communication to take place with any ESL in the aisle A. These ESLs are normally provided at a height that is less than head height from the floor in order to be easily read by a shopper. Thus a transceiver 10a, has to communicate with ESLs which are contained in a space S_{HSa} which normally at most extends from ground level to head height and is as wide as the width of an aisle between two rows of shelves and is preferably as long as the row of shelves. ESLs can be placed almost anywhere in this space on shelves, baskets, bins, etc. Therefore, transceiver 10a must produce signals that have sufficient strength to communicate with any ESLs anywhere within this space S_{HSa}. The boundaries B_{HSa} of this space for the transceiver 10a are shown in FIG. 1a.

As the tops of the low shelves LS1-LS3 are so far from the ceiling C, a transceiver 10c for line-of-sight communication or diffuse communication positioned above the middle of an aisle can normally communicate with ESLs not only in the aisle below it but also with ESLs in adjacent aisles. Thus, one transceiver 10c mounted to the ceiling above an aisle may be able to communicate with ESLs in three aisles. These ESLs are normally provided at a height that is less than head height from the floor. Thus a transceiver 10c for low shelving normally has to communicate with ESLs which are contained in a space S_{LSc} which at most extends from ground level to about head height and is as wide as the width of 2 aisles plus the width of a row of shelves between two rows of shelves, and is preferably as long as the row of shelves. Therefore, transceiver 10amust produce signals that have sufficient strength to communicate with any ESLs anywhere within this space S_{HSa}. The boundaries (i.e. the surfaces formed by all the points of the boundaries of the space) B_{LSc} of this space S_{LSc} for the transceiver 10c are shown in FIG. 1b.

In order to optimise the power requirements of the communication system, it is desirable that the radiation pattern generated by a transmitter for a space makes the signal-to-noise ratio (SNR) equal to the same constant at every point on the cell boundary (see “Wireless infrared communication”, John R. Barry, 1994, pages 39-40). If we assume that there will be a constant Noise level at all points of the cell boundaries, the SNR will only be dependent on the Signal, and therefore “constant SNR” can in this case be expressed as “constant signal level”. Thus an optimal transmitter will produce a signal which has the same signal strength on the whole of the boundary of the space containing units which it is intended to communicate with.

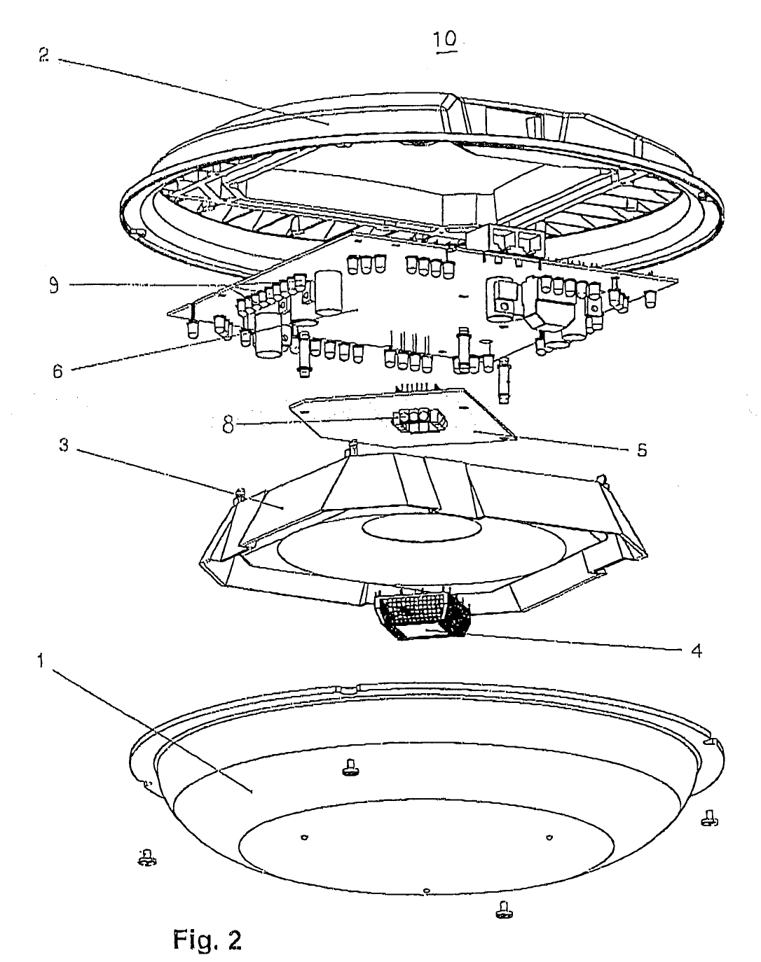

In FIG. 2, there is shown an embodiment of a transmitter device 10 according to the present invention. Said transceiver device 10 is comprised of a base structure 2, intended for mounting e.g. on or near to the ceiling of a facility in which the transmitter is to be installed, e.g, a consumer goods retail facility. In the base structure 2 is further provided a transmitter unit base member 6, in this embodiment comprised of a printed circuit board (PCB), on which the different components of the transceiver 10 are mounted. These components comprise at least one source of IR light, preferably in the form of one or more infra-red light emitting diodes 9 (IR-LEDs).

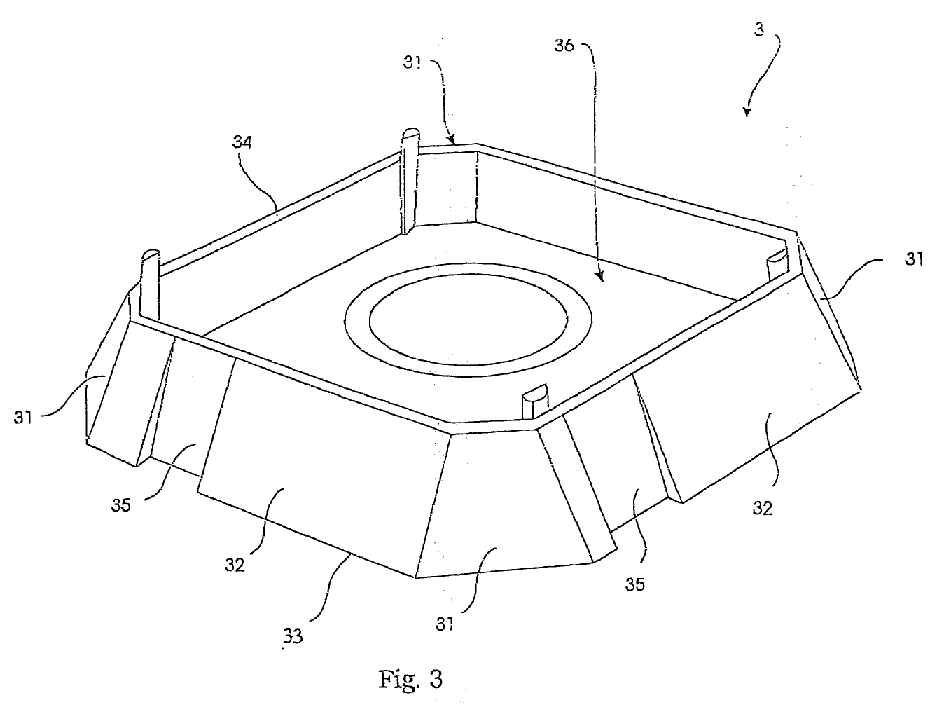

Preferably, the device according to the invention, as shown in FIGS. 2 and 3, comprises a combined transmitter and receiver, i.e. a transceiver unit, having a receiver unit 5 comprising at least one photosensitive element 8, preferably IR-photodiodes. In FIG. 2, twelve such elements 8 are mounted on the PCB. As can be seen in FIG. 2, the receiver unit is separate from the transmitter unit, and mounted on a separate PCB, enclosed by an electric shield element 4, that forms a Faraday cage for eliminating noise during signal reception. Although the receiver unit of FIG. 2 is shown as a separate unit it may, however, be mounted on the same PCB as the transmitter unit.

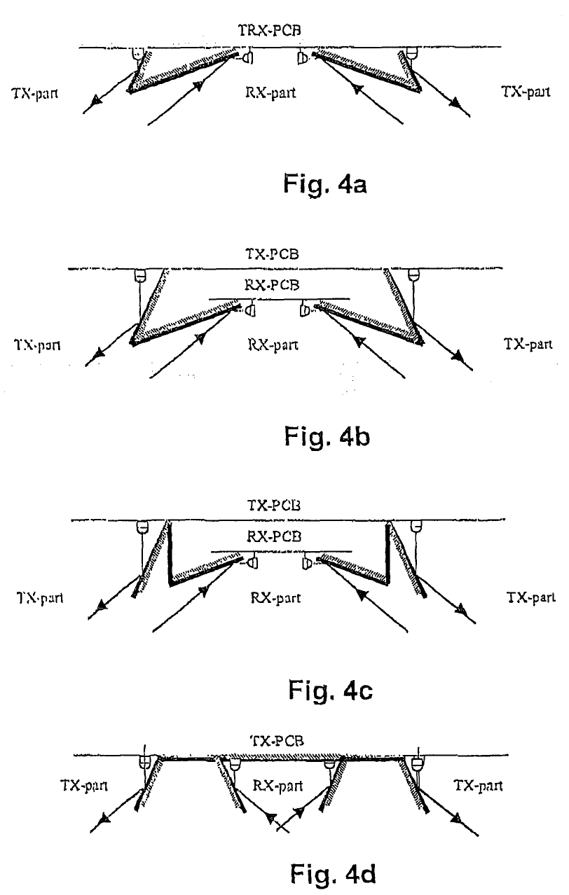

Other components mounted on the transmitter base member 6 can include components for converting a signal received from a central control unit communication different messages to said transceivers for further transmission to, for example, an electronic shelf label (ESL) (see FIG. 4), and/or for converting response signals received from said ESL for delivery to the central control unit. In FIG. 2, there is also shown an IR transparent cover 1 that can be mounted over the device.

The preferred embodiment of a PCB 6 for a transmitter unit 10 according to the present invention has a special design comprising a plurality of mounting slots (not shown in the figures) for the IR light sources 9. In this way one PCB design will cover a large number of embodiments of the transmitter unit adapted for different situations, as will be discussed in detail below.

According to the present invention reflecting surfaces are used for distributing the IR signals to the IR receivers, e.g. ESLs, such that the signal strength is substantially the same at any point of the boundary of the space containing ESL that the transceiver is intended to communicate with. An example of a reflector unit 3 comprising such reflecting surfaces is shown in FIGS. 2 and 3.

In FIG. 2 are also shown sources of IR light. In the preferred embodiment of the present invention, said sources of IR light are comprised of IR-LEDs 9 which are mounted on a PCB 6. The IR-LEDs 9 are mounted in a desired pattern on the PCB 6. Preferably, the PCB 6 is arranged so that there is a number of IR-LED mounting slots in which IR-LEDs 9 can be mounted. The number of mounting slots can be selected such that for certain applications all of the slots need not be fitted with IR-LEDs 9 and thus, depending on the need for signal strength and desired light distribution, the number of IR-LEDs 9 can be varied, in conjunction with the choice of reflector unit 3, all of which will be discussed in more detail below.

Thus, the IR-LEDs 9 are mounted in a desired pattern on the PCB 6, which pattern depends on the particular needs of the individual transmitter of transceiver unit. Adjacent the IR-LEDs 9 there is mounted a reflector unit 3, which in this embodiment is comprised of a number of reflecting surfaces 31-36 integrated into a single reflector unit 3. When the reflector unit 3 is mounted on the PCB 6, the light from the IR-LEDs 9 is reflected by the reflecting surfaces 31-35 in predetermined directions such that each reflecting surface 31-35 reflects the light of at least one IR-LED 9. The same applies for the central reflecting surfaces of the reflector unit, where each reflecting surface reflects light.

In FIG. 3, a specific embodiment of a reflector unit 3 according to the invention is shown. The reflector unit 3 has a generally octagonal box shape, having four larger edges and four smaller. The reflector is suitably made of a plastic material that is metallized to provide the mirror reflectivity. In view of the non-regular octagonal shape, there are smaller surfaces 31 at the corners, below referred to as corner surfaces, and larger surfaces 32 between corner surfaces, below referred to as side surfaces. The base or lower circumference 33 of the box is larger than the top or upper circumference 34, such that the side and corner surfaces 31, 32 of the box are inclined at an angle. The side surfaces 32 of the box are capable of reflecting light.

The reflecting side surfaces 32 are inclined at a respective angle in relation to the direction of the longitudinal axis of IR-LEDs 9, so as to be able to direct this light downwards and into the space which is intended to be covered by the light from the transmitter unit.

The angle of the reflecting side surfaces 32 relative to the direction of the light emitted by the IR-LEDs 9, is selected to be a function of the distance to, and the size of, the boundary surface of the cell or space to be covered. Since these boundary surfaces are relatively large surfaces, the required signal strength is also relatively high, and thus a relatively large number N of IR-LEDs 9 are mounted adjacent to the first reflecting surfaces 31, 32.

In each reflecting side surface 32, i.e. the surfaces extending between the inclined corner surfaces 31, there are recessed portions (two of these are hidden in FIG. 3), also forming inclined reflecting surfaces 35. The inclination of these surfaces differs from the inclination of the other surfaces and is adapted such that these reflecting surfaces 35 are capable of reflecting IR light over a part of the cell which is located below, and closer to the transmitter unit. In this direction, there is a need for fewer sources of IR light to achieve the required signal strength.

The reflecting corner surfaces 31 are also inclined at an angle relative to the longitudinal axis of IR-LEDs 9. This angle depends on the desired angular distribution of light towards a cell or space boundary surfaces. If this boundary surface is located closer to the transmitter unit, or is smaller in size, than the long side boundary surfaces of the cell or space, then the number n of IR-LEDs required is smaller than N, which is the case in this embodiment.

Finally, there is provided a slightly truncated-cone shaped, circular reflecting surface 36 (the non-reflecting upper side only is visible in FIG. 3), that is located in the middle of the reflector unit, spanning the area between the side surfaces at the lower edges thereof. This circular reflecting surface 36 is designed to receive incoming signals from peripherals e.g. ESLs. A circular opening is provided in the reflecting surface 36, where the receiving unit is positioned (not shown in FIG. 3). The surface 34 will reflect incoming signals towards the photosensitive means of a receiver unit provided centrally in the reflector unit 3, whereby said receiver unit 5 is capable or receiving signals emitted from substantially anywhere in said predefined space.

The reflector shown in FIG. 3 is designed to reflect the light over a space having a rectangular bottom area, and rectangular sides. In terms of optimising resources, the rectangular shape of the bottom area is preferable, since it is considered to be an optimal way of distributing IR signals over a predetermined area, which is to be covered by more than one transmitter or transceiver. In the case of ESL systems, this shape is often determined by the set-up of the facility, i.e. long rows of shelves where the ESLs are mounted. However, under certain circumstances, it may, be desirable to distribute the light over areas or spaces with other shapes, for example a polyhedral space.

The reflecting surfaces of the reflector unit shown in FIG. 3 are shown to have substantially plane, angled surfaces for accomplishing the desired signal power distribution. It is however equally possible to use curved surfaces, e.g. for the reflecting surfaces used for receiving, where in some cases it might be advantageous to cover as large a receiving angle as possible, depending on the set-up of the facility in which the transceiver unit is installed.

The above also applies for the possible reception of signals from a remote transmitter. The designs of the reflecting surfaces for reflection of incoming signals to be received are such that they will allow for the reception of IR signals emitted by, for instance, an ESL, where said signals have a strength which is above a predetermined minimum energy, and which may be transmitted from substantially anywhere within the space covered by the transceiver unit.

In this way, the effort in terms of time and costs, for tailoring a transmitter or transceiver unit for its working environment is greatly reduced. The PCB 6 may be manufactured in one basic embodiment comprising a number of mounting slots for IR-LEDs 9, and possibly also for photodiodes, even though they may be mounted on a separate PCB which in turn is mounted on the PCB 6 on which the IR-LEDs 9 are mounted. Depending on the working environment of the transmitter or transceiver unit, an appropriate number of IR-LEDs 9 are mounted, in the appropriate mounting slots, possibly leaving some slots empty, and suitable reflector designs are chosen. Thus, in this way a transmitter or transceiver unit can be tailored to meet the demands of its working environment in terms of optimising the signal strength distribution in its space of coverage. Thus, a transmitter or transceiver unit may be easily adapted to any desired distribution pattern.

In terms of production facilitation, it may suffice to provide a limited number of reflector designs to cover almost all possible cases. It will also suffice with a limited number of PCB designs, one for each size, thanks to the PCB design with mounting slots for the sources of IR light.

It may of course be possible to use a transceiver design in which the photo-sensitive means 8 are arranged on the PCB 6 alongside the IR-LEDs 9, using the same reflecting surfaces, even though this may be less than optimal in terms of avoiding noise in reception.

The principles for the design of the reflecting member will now be described. The signal strength received from the transmitter in a direction X is inversely proportional to the distance in the direction X from the transmitter to the receiver. At the time of designing a transmitter it is not known exactly where each ESL will be located in the space which the transmitter is intended to cover. Therefore the optimum use of transmitter power is to distribute the signal energy so that all the points on the boundary of the space have the same signal strength. In one method that can be used, namely the “point to point” model, relative transmitter power is proportional to the inverse squared distance from the transmitter to the boundary surface. (Point to point model mathematics can be used also for diffusive IR-signals as a first approximation, more advanced methods of defining the desired signals using e.g. ray tracing algorithms can also be used but are part of the prior art known to the skilled person and are not described here). This will give the necessary angular characteristics of the transmitter and hence the design of the reflector to be used in the transmitter can be defined from the IR-light source position(s) and radiation pattern of the IR-light source. The same applies for the receiver part of a IR-communication product.

Thus, it will pertain to the field of the skilled man by routine experimentation to find suitable angles for the respective reflecting surfaces for general and specific applications.

In FIGS. 4a-d several possible embodiments of the reflector 3 employing the principles according to the invention are disclosed.

The common feature of all embodiments is that light is transmitted in essentially the same directions, and also received from the same directions. However, the provision of PCB's (Printed Circuit Board) carrying the LED's differ, and thus the geometrical design of the reflector 3 will also differ, but the end result will in terms of the space covered be the same.

Thus, in FIG. 4a all LED's are mounted on one and the same PCB (TRX-PCB), whereas in FIG. 4b the transmitting TRX and receiving RX LED's are mounted on separate PCB's.

FIG. 4c corresponds to the design described and shown in FIG. 3. Also in this embodiment there are separate PCB's for TRX and RX respectively.

Finally, in FIG. 4d still another embodiment is shown. In this variant the receiving reflector has a different design compared to the other three embodiments. In FIGS. 4a-c the receiving surface (34 in FIG. 3) is shaped as a flat cone, and has a generally circular extension, whereas the corresponding surface in FIG. 4d is inverted in comparison with the cone of the other embodiments.

Arrows indicate the direction of transmitted and received light. As can be seen, the resulting beam patterns are the same in all embodiments.

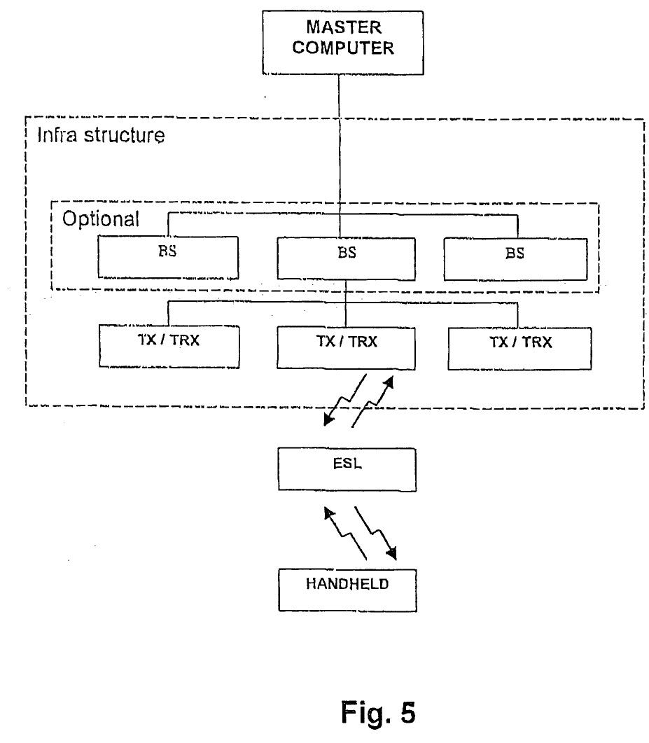

In FIG. 5 there is shown a schematic representation of the system according to the invention.

It comprises a MASTER COMPUTER, centrally located in a facility such as a shop. The MASTER COMPUTER contains the software necessary for controlling the operation of the system.

The Infra Structure of the system comprises the transceiver units TX/TRX, and optionally Base Stations BS, each serving a plurality of TX/TRX units. The TX/TRX units may communicate via infra red light (indicated by arrows) with the Electronic Shelf Labels ESL. Radio communication is also possible. The ESL's can be updated by handheld devices, also by employing infrared or radio communication (arrows).

The system according to the present invention is assembled by providing a reflector unit 3 which is designed to distribute the infra-red light in a predefined space such that a substantially uniform signal power distribution is achieved on selected boundary surfaces of the predefined space. In accordance with what has been mentioned above concerning the design of the reflector unit, one or more standard designs which are designed to each cover a different shaped area, can be provided.

Furthermore, reflector units 3 may be provided for covering different sized areas. It may then be necessary to modify the electronic hardware of the transmitter unit, so as to provide a higher or lower delivered signal power, as desired. This may be done by providing a larger or smaller number of IR-LEDs 9, or using IR-LEDs 9 delivering a higher or lower signal power. The shape of the reflector unit 3 may then be altered accordingly, to provide a coverage in accordance with the conditions dictated by the set-up of the facility in which the transmitter or transceiver unit is installed, i.e. distance to, and size of, the boundary surfaces intended to be covered by means of the transmitter unit, or by other constraints affecting the transmission of messages between the transmitter or transceiver unit and a remote receiver.

While in the embodiments described above a single reflector unit in a transmitter is employed, it is of course conceivable to use two or more reflector units in a transmitter unit to achieve the desired signal distribution.

Naturally, various modifications of the invention are possible, and the present invention is not intended to be limited to those described above but is to include any such modifications that fall within the scope of the present invention, which is solely defined by the appended patent claims.

1. Optical transmitter unit (10) for transmitting messages by means of infra-red signals to electronic units (ESL) located in a predefined space having a number of boundary surfaces, said transmitter unit having at base member (6) and at least one source of infra-red light (9) mounted to said base member (6);
characterized by
a reflector unit (3) having at least one reflecting surface (31, 32, 34, 35), the reflector unit being mounted on said base member (6), and the reflecting surfaces being arranged adjacent said source(s) of infra-red light so as to direct light from said light source(s) in a direction such that an essentially uniform power distribution is obtained on one or more selected boundary surfaces of said predefined space.

2. Transmitter unit according to claim 1, wherein said reflector unit comprises two or more reflecting surfaces (31, 32, 34, 35) for transmission, each of said reflecting surfaces being arranged to reflect the light from at least one source of infra-red light.

3. Transmitter unit according to claim 1 or 2, further comprising a receiving unit (5, 8) with means (8) for receiving a response message signal from said electronic units (ESL), and at least one reflection surface (36) for reflecting said response message signal onto said receiving means (8).

4. Transmitter unit according to any of claims 1-3, wherein all reflection surfaces (31, 32, 34, 35; 36) are integrated in the same reflector unit (3).

5. Transmitter unit according to any of the preceding claims, wherein the individual reflection surfaces are substantially plane.

6. Transmitter unit according to any of the claims 1-5, wherein the individual reflection surfaces are curved.

7. Transmitter unit according to any of the preceding claims, wherein the base member (6) is comprised of a printed circuit board (PCB).

8. Transmitter unit according to any of claims 5-7, wherein each reflection surface (31, 32, 33, 34, 35) for transmission is associated with two or more of the sources of IR light.

9. Transmitter unit according to any of the claims 3-8, wherein said receiving unit (5, 8) is comprised of a separate base member (5) on which photosensitive members (8) are attached, said receiving unit being attached to the base member (6) of the transmitter unit.

10. Transmitter unit according to any of the claims 3-9, wherein said receiving unit (5, 8) is shielded by electrical shielding means (4) forming a Faraday cage enclosing said receiving unit.

11. Electronic shelf label system, comprising:
a central control unit (MASTER COMPUTER) for providing message signals;
a set of electronic shelf labeled (ESL), each label having an infra-red message signal receiver; and
a transmitter unit (10) according to any of the claims 1-10.

12. The label system according to claim 11, wherein the shelf labels (ESL) also comprise a transmitter for transmitting acknowledgement signals back to the system, whereby said transmitter unit (10) also comprises a signal receiving unit (5, 8).
